(19) United States
(12) Patent Application Publication
(10) Pub. No.: US 2005/0142325 A1
(43) Pub. Date: Jun. 30, 2005

(54) Primary carpet backing

(75) Inventors: Jannes Veurink, Brummen (NL); Leonardus Lucas, Duiven (NL); Pieter Hendrik Zuuring, Nijmegen (NL); Michal Szoltek, Giesbeck (NL); Marten Oosterbroek, Westervoort (NL); Leonardus Gerardus Cornelis Bouwmans, Didamn (NL)

Correspondence Address: OLIFF & BERRIDGE, PLC, P.O. BOX 19928, ALEXANDRIA, VA, 22320, US

(73) Assignee: Colbond B.V., Arnhem (NL)

(21) Appl. No.: 10/504,683

(22) PCT Filed: Feb. 11, 2003
(86) PCT No.: PCT/EP03/01302

(30) Foreign Application Priority Data
Feb. 15, 2002 (EP) 02003505.1

(51) Int. Cl. B32B 3/02; B32B 33/00; D04H 1/00; D04H 3/00

(52) U.S. Cl. 428/95; 442/364; 442/409

(57) ABSTRACT

A nonwoven fabric is provided for a primary carpet backing comprising a bicomponent filament of polymeric core/sheath-type, the polymeric core component of which has a higher melting point than the polymeric sheath component, said bicomponent filaments are bonded together by the application of heat to form said fabric, characterized in that the polymeric sheath component is selected from the group containing polypropylene and copolymers comprising polypropylene and/or blends thereof. The invention is further directed to a process of manufacturing such nonwoven fabrics and to articles, such as car carpets, comprising them.

### BACKGROUND OF THE INVENTION

1. Field of Invention

The invention relates to a nonwoven fabric for a primary carpet backing comprising a bicomponent filament of polymeric core/sheath-type, the polymeric core component of which has a higher melting point than the polymeric sheath component, said bicomponent filaments are bonded together by the application of heat to form said fabric.

2. Description of Related Art

A spun bonded fabric consisting of polyester matrix filaments that is suitable for use as a tufting base for carpets is known from U.S. Pat. No. 4,842,915. The bonded-fabric base consists of polyester matrix filaments and is bonded with polyolefins as the binding component. The binding components are in the form of thermoplastically softenable filaments consisting of advantageously polypropylene.

Primary carpet backings comprising spun bonded fabrics including binding fibers often show dissimilarities in their appearance. Moreover, the overall strength of the fabrics in many cases leaves room for improvement.

Furthermore, nonwoven fabrics comprising bicomponent filaments having a polyethylene terephthalate core and a polyamide sheath, in the following also referred to as PET/PA bicomponent filaments, suitable for primary carpet backings are known. The nonwoven fabrics based on PET/PA bicomponent filaments are easily moldable and show good homogeneity and also considerable strength when used in primary carpet backings.

Unfortunately, molded carpets containing a primary backing based on PET/PA exhibit a relatively high shrinkage. Molded carpets are known to the person skilled in the art and need not to be elucidated here. Also a relatively high molding temperature is necessary when manufacturing car carpets having primary carpet backings on PET/PA basis.

### SUMMARY OF THE INVENTION

The present invention seeks to at least reduce the problems mentioned above. Furthermore, it has for its object to provide a nonwoven fabric useful as a primary carpet backing, which is easily and inexpensively manufactured, shows a good long term stability and easy molding behavior.

Surprisingly, the object of the invention can be achieved by a nonwoven fabric as described in the opening paragraph, wherein the polymeric sheath component is selected from the group containing polypropylene and copolymers comprising polypropylene and/or blends thereof. Especially preferred is homo-polypropylene.

In comparison to the nonwoven fabrics useful for primary carpet backings of the prior art, the nonwoven fabric according to the invention exhibits an improved homogeneity due to the fact that there are no binding fibers necessary and at the same time has an abundance of bonding points, which renders the fabric strong and resistant against mechanical demands. The nonwoven fabric of the present invention thus entirely consists of bicomponent filaments. As a consequence every contact between filaments during the bonding step returns in a bond point. In contrast to that, the nonwoven fabrics of U.S. Pat. No. 4,842,915 always contain to a certain extent filaments consisting of only one polymer type, i.e., the polyester matrix.

### DETAILED DESCRIPTION OF PREFERRED EMBODIMENTS

A car carpet comprising a nonwoven fabric of the invention can be molded more easily and will show lower shrinkage after molding. In fact, the polypropylene forms a continuous phase covering the core polymer everywhere in the nonwoven fabric. As a consequence of the high chemical inertness of the polypropylene, the nonwoven fabric also shows good resistance against chemicals. Many carpets have to be dyed after tufting; the hydrophobic nature of the continuous phase diminishes the pick up of the dyestuff, which is an economical advantage.

It is of further advantage for the nonwoven fabric of the invention when the melting point of the polymeric core component is more than 30° C., preferably more than 50° C., higher than the melting point of the sheath component. A relatively large difference between the melting temperature of the polymeric core component and the binding or molding temperature while forming the nonwoven fabric prevents the degradation of the mechanical properties of the polymeric core component during processing. In addition to the low degradation of the polymeric core component while binding, there is also less structural change of the core component, which ensures that the overall properties of the bicomponent filaments are better retained.

When applying polypropylene as the polymeric sheath component, the bonding temperature is substantially lower than in case of e.g., polyamide 6, which requires a higher temperature.

For the polymeric core component, it is preferred that it is selected from a group containing polyethylene terephthalate, polybutylene terephthalate, polyparaphenylene terephthalamide, aliphatic polyamides, polyphenylene oxide and/or co-polymers or blends thereof. Polyethylene terephthalate as polymeric core component is most preferred.

It is sufficient when the ratio of the polymeric core component to the polymeric sheath component is in the range from 60:40 to 95:5% vol./vol. A typical example reads 73 vol.-% of polyethylene terephthalate as polymeric core component and 27 vol.-% of polypropylene.

The polymeric core/sheath type bicomponent filaments of the nonwoven fabric according to the invention ensure large contact surfaces and form bonding points of good strength and distribution.

The linear density of the bicomponent filaments is usually in the range between 1 and 25 dtex, preferably between 2 and 15 dtex.

When used in primary carpet backing, the nonwoven fabric of the invention combines long-term stability and easy molding. Also in terms of tufting, it shows a good performance, i.e., good mechanical anchoring realized with a single nonwoven without additional modifications, which renders further layers in the primary backing redundant.

As already indicated above, the present invention is also directed to a carpet comprising a primary carpet backing, wherein the primary carpet backing comprises a nonwoven fabric according to the invention.

It is noted that JP 2-139465 discloses a nonwoven fabric for a secondary carpet backing, the nonwoven fabric is made up of a core-sheath-type composite fiber with polyethylene terephthalate as the core component and polypropylene as the sheath component. This publication, however, neither discloses nor teaches that the nonwoven can be used for primary carpet backings.

A particularly preferred embodiment is a car carpet comprising a primary carpet backing, wherein the primary carpet backing comprises a nonwoven fabric according to the invention.

The present invention is also directed to a process for manufacturing a nonwoven fabric for use as a primary carpet backing comprising the steps of providing a bicomponent filament of polymeric core/sheath-type, the polymeric core component of which has a higher melting point than the polymeric sheath component, bonding said bicomponent filaments together by the application of heat to form said fabric, wherein the polymeric sheath component is selected from the group containing polypropylene and copolymers comprising polypropylene and/or blends thereof.

The invention will now be further elucidated by the following non-limiting example.

### EXAMPLE

Bicomponent PET/PP yarn is produced using a known melt spinning technique and a core/sheath spinneret, such that each filament has a core/sheath geometry, where the core is made from polyethyl terephthalate(PET) having a relative viscosity of 1.65 and the sheath of polypropylene with a melt flow rate (MFR) of 23 g/10 min at 230° C./2.16 kg according to ISO 1133. The relative viscosity of PET reflects the viscosity that would be obtained using 1 g/100 g PET in m-cresol. The core/sheath ratio amounts to 73.7/26.3 (v/v).

The filament bundle was cooled in a blow-box and a subsequent chute. In the take up section, the yarn was stretched 2.1 times and wound up at a speed of 2320 m/min. Total yarn count was 1200 dtex.

Nonwovens have been made from these yarns using a web-laying machine followed by thermal bonding at 165° C.

The resulting nonwoven weighs 120 g/m². The strength in machine and cross machine direction is 360 and 330 N/5 cm. The strain at break amounts to 80%. The nonwoven is suitable as primary backing in car carpets. A molded carpet with good dimensional stability has been obtained after the necessary process steps, as tufting, dyeing, coating, application of a heavy layer and a secondary backing, and molding. The shrinkage of the deep drawn molded carpet is less than 2% in machine direction and 0% in cross machine direction after treatment at 160° C. during 15 minutes.

1. A nonwoven fabric for a primary carpet backing comprising bicomponent filaments of a polymeric core component and a polymeric sheath component, the polymeric core component of which has a higher melting point than the polymeric sheath component, wherein said bicomponent filaments are bonded together by the application of heat to form said fabric, and wherein the polymeric sheath component is selected from the group consisting of polypropylene, copolymers comprising polypropylene and blends thereof.

2. The nonwoven fabric according to claim 1, wherein the melting point of the polymeric core component is more than 30° C. higher than the melting point of the polymeric sheath component.

3. The nonwoven fabric according to claim 1, wherein the polymeric core component is selected from the group consisting of polyethylene terephthalate, polybutylene terephthalate, polyparaphenylene terephthalamide, aliphatic polyamides, polyphenylene oxide co-polymers thereof and blends thereof.

4. The nonwoven fabric according to claim 1, wherein the ratio of the polymeric core component to the polymeric sheath component is in the range from 60:40 to 95:5 v/v %.

5. A carpet comprising a primary carpet backing, wherein the primary carpet backing comprises the nonwoven fabric according to claim 1.

6. A car carpet comprising a primary carpet backing, wherein the primary carpet backing comprises the nonwoven fabric according to claim 1.

7. A process for manufacturing the nonwoven fabric for the primary carpet backing according to claim 1 comprising the steps of providing the bicomponent filaments having the polymeric core component and the polymeric sheath component, the polymeric core component of which has a higher-melting point than the polymeric sheath component, bonding said bicomponent filaments together by application of heat to form said nonwoven fabric, wherein the polymeric sheath component is selected from the group consisting of polypropylene, copolymers comprising polypropylene and blends thereof.

8. The nonwoven fabric according to claim 1, wherein the melting point of the polymeric core component is more than 50° C. higher than the melting point of the polymeric sheath component.

9. The nonwoven fabric according to claim 1, wherein the polymeric sheath component is polypropylene.
